(19) United States
(12) Patent Application Publication
(10) Pub. No.: US 2015/0294527 A1
(43) Pub. Date: Oct. 15, 2015

(54) SYSTEM FOR VIRTUAL INTELLECTUAL LOTTERY GAMES

(71) Applicants: Volodymyr Kolomiiets, Cherkassy (UA); Kirsan Ilyumzhinov, Elista (RU)

(72) Inventors: Volodymyr Kolomiiets, Cherkassy (UA); Kirsan Ilyumzhinov, Elista (RU)

(21) Appl. No.: 14/249,436

(22) Filed: Apr. 10, 2014

(51) Int. Cl. G07F 17/32

(52) U.S. Cl. CPC G07F 17/329; G07F 17/3225

(57) ABSTRACT

A system for organizing virtual intellectual lottery games based on the occurrence of live competitive events. As professional players compete in a real game, a virtual game is organized, where gambling players have the chance to predict each move within the real game. As the real game proceeds, virtual players accumulate points based on the number of correctly predicted moves. The prize pool is generated as gambling players join the virtual game and make bets. Prize distribution is based on point accumulation and speed of prediction. The system is accessible via the Internet, other networks, mobile communications, and system terminals in various locations.

### FIELD OF THE INVENTION

The claimed invention relates to systems for virtual intellectual betting games based on real events, and particularly those lottery games carried out via the Internet and mobile devices.

### BACKGROUND OF THE INVENTION

Several systems for online lotteries exist today. One known system uses a telephone network, which helps in the registration of participants and formation of individual numbers required to participate in the lottery, as well as identification of each participant and compilation of the prize pool.

Another known system, Patent No. RU 2314853 C1 (Utolin, K.V.), creates networked computer games in local and global computer networks (such as the Internet) involving many players. Among other applications, it is intended for entertainment and tournaments based on board games such as Chess, Go, Renju, Checkers, Roulette, and economic games (e.g. Monopoly, etc.), or card games such as Solitaire, Bridge, and Poker. Players register with a name and receive a personal password to access the website or webpage. On the webpage, different games are listed, along with rules for participation and rules for each game, and players have the ability to join the games. After a game begins, several players can combine to make one team (or individual) within the chosen game. Each player can suggest each move that the team makes as a group, and all members of the team then vote/decide which move to make. This must all be done in a certain amount of time. This process continues throughout the game, with different players making up the different teams/individuals within the game. Every final team decision is then recorded by the system and displayed on the public board. At the same time as the game is played, a winning fund (in the form of material, financial, informational, or intellectual property) is created from the players playing the game, which is rewarded to and shared by the players of the game-winning team.

Additionally, a well-known chess-training game, Guess the Move, discloses a process where participants guess each next move of famous chess players, who actually played in the past on a related webpage setup by the game organizer. Participants guess moves correctly to accumulate points and can compare their points with other players. Participants can guess randomly or based on the relevant details of the given game. The first few moves of each game are displayed automatically, and then participants must guess each move by pressing the corresponding key within an allotted time. The participant has two ways of entering each move: (1) move a shape on the website (the server data automatically displays on the game board), or (2) enter an alphabetic and/or numeric designation. Once the game ends, the participant is given a final score and the opportunity to review the progress of the game just played.

### SUMMARY OF THE INVENTION

A computer system for the running of virtual intellectual games, where players can place bets predicting each successive move of a live event, usually a live table game such as Chess, Checkers, and Go. While betting, players have the ability to watch a video of the live event, receive updates in the form of a results table as the game progresses, and can view a leaderboard comparing the scores of all participating players. Points are accumulated based on the amount of correct move predictions and each player's speed of prediction. The system is accessible via the Internet, mobile communications, and/or game terminals in various locations.

### BRIEF DESCRIPTION OF THE DRAWINGS

FIG. 1 shows an example of how the different units and files of the claimed system might interact within a specific game.

FIG. 2 shows a smart phone screen during the lottery.

### DETAILED DESCRIPTION OF THE PREFERRED EMBODIMENT

This invention relates to systems for the construction of virtual intellectual lottery games based on the individual actions, or moves, of real professional players participating in a real event (e.g. a competition, a tournament, a game, a sporting event, etc.). Via the Internet, mobile communications, and a data processing and analysis software-hardware complex, the system provides for the placement of bets (made by participating members), in numeric and/or graphic format, on certain actions, or moves, of the professional players, as well as the formation of a prize pool from which the winnings are distributed to winning participating members. The claimed system can apply to games including, but not limited to, Chess, Checkers, Go, Poker, Bridge, and other intellectual games.

The claimed system achieves the objective and technical result of creating a new virtual intellectual lottery game platform, where participants can place bets (to win a prize) on the actions of real professional players within a real game, which is displayed concurrently and in real time on the chosen game page. It allows to improve the ability to detect and record using hardware and software intellectual skill level gifted individuals among members of virtual intellectual games by the hardware-software complex of the system which compares the bets made to the real actions performed, thus analyzing the betting field for those participants who predict with higher accuracy. The system gives a high potential for growing intellectual skill level of participants and brings to intellectual games the masses of new members through a virtual tournaments using the principle of material incentives.

The system is comprised of a virtually constructed network, where intellectual table games, such as Chess, Go, Checkers, Poker, Bridge, etc., are played by people (e.g. professional players) in real time (hereafter “real members” or “real players”) and bet on virtually by online participants (hereafter “betting members” or “betting players”). The betting members have the opportunity to guess the moves of the real members. The guessing, or betting, process is performed concurrently with the game being played in real time. Betting members can view the event and statistics and place bets by using mobile communications to introduce alphanumerical notation, using a website on the Internet or other network with a screen interface, or by using a game terminal and moving objects on the playing field, with subsequent transfer of the information to the game server.

The system provides for registration of betting members and assignment of a user name and password for each participant who desires to be a betting player. The game server contains a game selection page, where each game is displayed alongside rules for participation and rules for each respective game. Any number of betting players may enter any number of games by selecting the game they choose to play from the game selection page. By selecting a specific game, betting players enter the betting page. There, betting members accumulate points by correctly predicting each successive move of the game being played. Betting members' points are determined and compared by the hardware-software complex of the system, and prizes are distributed based on point differentials. The prize pool is generated from betting member payments (e.g. via game or system membership fees) as well as contributions from the system organizer.

Within the system, and more specifically within each game of the system, two games are played concurrently—a real game is played between playing members and a virtual game is played between betting members, wherein the betting members attempt to predict each move, or action, of each playing member. The real game is linked, through the hardware and software of the system, to the virtual game, such that the virtual game can follow the real game. The real game is displayed in real time on the betting page, and the virtual game proceeds accordingly. As the real game proceeds, each move of each real player is displayed (e.g. in table format) on the betting page (note: each betting player views the same betting page, except for one element specific to his/her bets, described below). Before each move, each betting member has the opportunity to predict the move/action which they believe the real player will make. Once the move is made, betting members lose this opportunity as well as the chance to gain points for that action. The displayed personal results show the betting member the prior real moves made, the betting member's predictions compared to those moves, and the points accumulated (note: this element of the betting page is distinct and unique for each individual betting member). In addition to personal results, the betting page displays a leaderboard, showing total point comparisons among all the betting members signed into the game.

In one embodiment of the claimed system, betting members are provided with options for each action, which are based on commonly-known strategies and the well-known rules of the game being played. In comparison, another embodiment of the claimed system does not provide any suggested moves, forcing the betting member to decide each move/action without any computer assistance.

Betting members are invited, and encouraged, to bet on every move made within a game. Betting members are also allowed the option to bet on only one team or individual within the game or, in the alternative, on several teams/individuals within the game. Each betting member can bet on each move, accumulating points for each move correctly predicted within the actual game. Betting member fees are determined based in part on the number of bets made and the number of teams/individuals chosen.

The point accumulation can be further described as follows. The predicted move information from each individual betting member is transferred to the game engine software of the system, wherein the software performs a comparison of the actual game move with the predicted move information. If the comparison results in a match, the game engine software sends a positive signal back to the betting member file, resulting in point accumulation (at least one point, further based on the specific rules of the game being played). If the comparison results in a mismatch (i.e. the prediction was wrong), game engine software sends no signal back to the betting member file, resulting in no point accumulation for that specific move. This process applies simultaneously and individually to each betting member making a prediction, and it is repeated for each round of predictions.

In one embodiment of the present invention, the point accumulation is additionally based on the amount of time it takes the betting member to predict the next action. Since the real game proceeds in real time, the betting member has a finite amount of time to predict each successive move. The faster the betting member submits his/her prediction, the more points that betting member will be eligible to accumulate (if his/her prediction is correct).

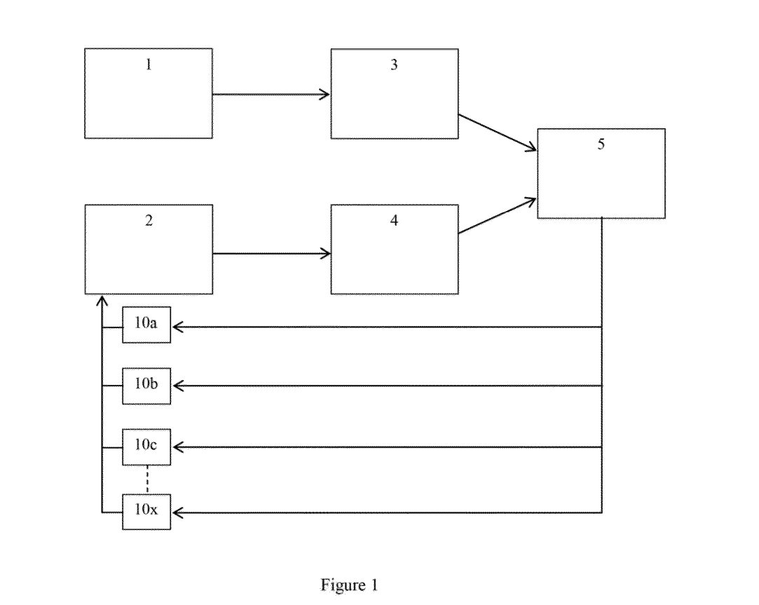

FIG. 1 shows one embodiment of how the elements and files described above might interact. Each betting member who joins to participate in a game receives a betting member file 10a, 10b. 10c . . . 10x, where the betting member's personal game statistics are stored. These statistics help to build the unique personal results that each betting member sees on their game screen. When a betting member submits a prediction, the betting member file 10, 10b, 10c . . . 10x sends the prediction data to the virtual game unit 2, which marks the submission with a timestamp (for point determination) and forwards the data to the virtual data unit 4, where the data is organized according to betting member number. Meanwhile, and simultaneously, as the real game 1 proceeds in real time, each successive move or action made is recorded, turned into data, and transferred to the real data unit 3, where the data is grouped according to each professional playing the real game. The real data unit 3 and virtual data unit 4 concurrently send their respective organized data to the processing unit 5, which compares the data to determine any potential winning predictions. If a given betting member prediction matches the present action of the real professional player, the processing unit 5 sends a signal to the corresponding better member file, thus awarding the betting member at least one point. The timestamp given by the virtual game unit 2 also plays a role in determining the amount of points awarded (e.g. an earlier correct submission will earn more points than a later correct submission). If a given betting member prediction does not match the present action, no signal is sent to the corresponding better member file, and thus no points are rewarded. This process occurs continuously and repeatedly as the real game proceeds and each move is made. This process occurs within every specific game offered by the claimed system.

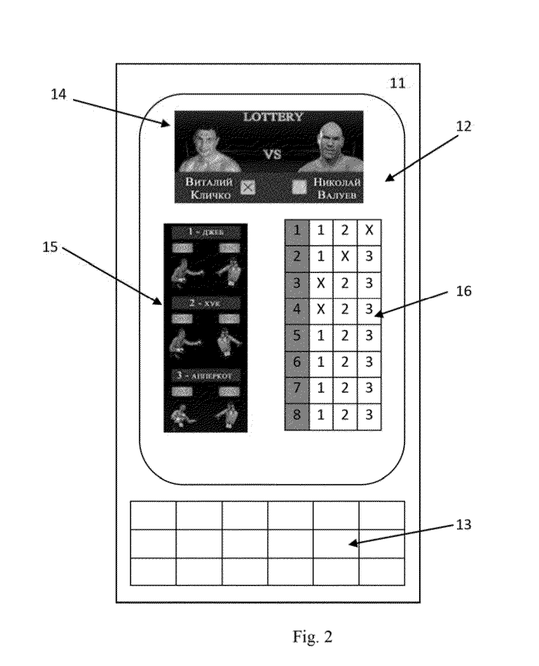

An example of boxing competition game is shown in FIG. 2. The smart phone 11 has a screen 12 and keyboard 13. The real fight is between two boxers shown in the window 14. During the fight the player, the owner of the smart phone, predicts the next move. The types of moves are shown in the window 15. The player prediction is shown in the window 16. Currently, four moves are already predicted, shown as X.

Optionally the player's choice of the next move may be inserted via touch screen.

A practical application of the presently claimed system can be offered using the game of Chess as an example. A real game occurs between real chess players. This game can occur, for example, in the Olympics, tournaments, other competitions, or even privately between professional players. The board and chess pieces being used by the real players are connected, through hardware and software, to the operator of the virtual game pages. On the virtual chessbetting page, each participating betting member is able to view several elements: (1) an emulated chess board following the real time game; (2) a video or image (streaming or recorded) of the chess game in real time; (3) a display of personal results (e.g. a table) showing point accumulation/earnings; (4) a leaderboard, comparing all betting members' point totals for the chess game; (5) buttons/tools for selecting each successive bet. Each betting member has the opportunity to place a bet on every move made in the real game. Alternatively, a bet may be placed on a sequence of moves or a variation. For example, a betting member can place a bet on one of opening variations that White uses against the Sicilian Defense (1.e4 c5) other than the most common plan of 2.Nf3 followed by 3.d4 cxd4 4.Nxd4 (the Open Sicilian). Some Anti-Sicilians include the Alapin Variation (2.c3), Moscow Variation (2.Nf3 d6 3.Bb5+), Rossolimo Variation (2.Nf3 Nc6 3.Bb5), Grand Prix Attack (2.Nc3 Nc6 3.f4 g6 4.Nf3 Bg7 and now 5.Bc4 or 5.Bb5), Closed Sicilian (2.Nc3 followed by g3 and Bg2), Smith-Morra Gambit (2.d4 cxd4 3.c3), and Wing Gambit (2.b4).

The betting member can also choose whether to play as a single chess player (i.e. predict the moves of only one chess player) or as both chess players. By interacting, clicking, or moving the buttons/tools element on the virtual game page, the betting member places his/her bet for each successive real move made. It should be noted that the betting member must place his/her bet before the actual move occurs in the real game. If the bet is not made in a timely fashion, the opportunity to predict that individual move is forfeited. Thus, as the real chess game proceeds, the virtual game follows it and the emulated chess board, display of personal results, and leaderboard grow and change accordingly. The winning betting members are determined by the following two criteria: (1) number of correct predictions of real moves made within the chess game, and (2) time spent in placing each bet (e.g. an earlier-placed bet will receive more points than a bet made right before the real move occurs).

Another embodiment of the present invention includes a tennis game. The betting member can place his bet not only on each serving result, but, alternatively, on each set results without mentioning its score. Thus the betting can be placed either on each move or on each part of the game longer than one move.

The description of a preferred embodiment of the invention has been presented for purposes of illustration and description. It is not intended to be exhaustive or to limit the invention to the precise forms disclosed. Obviously, many modifications and variations will be apparent to practitioners skilled in this art. It is intended that the scope of the invention be defined by the following claims and their equivalents.

What is claimed is:

1. A lottery system comprising:
a real data unit collecting real move data from a live sport event,
a virtual data unit simultaneously collecting betting player submissions for each successive move made in the live event, the submissions are transmitted from player's smart devices prior to a corresponding move;
and a processing unit comparing said real and virtual data to determine matching data, thus designating a winner among the players; the winner being a player with a larger number of correct move predictions.

2. The system of claim 1, wherein the player's smart device has a display; the display comprising:
a first window showing participants of the real game;
a second window showing a set of possible moves; and
a third window showing the player's prediction of a next move.

3. The system of claim 2, wherein the third window shows if the player's prediction was correct or not.

4. The system of claim 2, wherein the display is a touch screen, and the player makes his predictions by touching the screen in the third window.

5. The system of claim 1, further comprising a virtual game time unit, wherein each betting player submission receives a timestamp to be processed by said processing unit in determining a winning point amount, and the winner being a player who sent his submissions earlier compared to another player with the same number of correct move predictions.

6. The system of claim 1, wherein said real data unit, virtual data unit, and processing unit work in a continuous and repeating fashion as each successive real move is made.

7. The system of claim 1, wherein the smart device is a mobile phone or a tablet.

8. The system of claim 1, further comprising a display icon on the player's smart devices showing standing of each player compared to others.

9. The system of claim 1, wherein the moves are chess game moves.

10. The system of claim 1, wherein the moves are results of tennis game sets.

11. system of claim 1, wherein the moves are boxing game moves.

12. A system for virtual intellectual games, comprising:
one or more intellectual games being played by real members in real time,
a real game data unit for collection of move information from said intellectual game,
a plurality of betting members who, concurrently with the real game, place bets predicting each successive action of the real members within said intellectual game,
a betting data unit for collection of said betting members' bets,
a processing unit for comparison of real game data with betting data, wherein bets matching real game moves result in point accumulation for a betting member,
and a prize distribution among betting members based on total point accumulation.

13. The system of claim 12, wherein the prize is a monetary prize collected from the betting members.

14. A computerized system for organization of virtual intellectual games, comprising:
inviting players to place bets on individual moves in a live game played concurrently by professionals,
registering each betting player's selection with a computer, wherein the computer performs a comparison of a predicted move and an actual move, thus determining whether said selection earns an amount of points,
repeating said registering, comparison, and determination for each consecutive move of the live game, and determining a winner based on a larger amount of points earned.

15. The system of claim 14, wherein the steps are repeated for every new move made in the live game.

16. The system of claim 14, wherein said set amount of points is further determined by the speed time with which said selection was made by the betting player.

17. The system of claim 14, wherein the game is chess game and the betting is placed not to a single move but to a sequence of moves or a variation.

18. The system of claim 17, wherein the betting is also placed to a single move.

19. The system of claim 14, wherein the betting is for each set, not each serving.

20. The system of claim 14, wherein betting is placed for a result of any part of the game longer than one move.
